(19) United States
(12) Patent Application Publication
(10) Pub. No.: US 2026/0188008 A1
(43) Pub. Date: Jul. 2, 2026

(54) METHOD, APPARATUS, DEVICE, MEDIUM AND PRODUCT OF VIDEO ANNOTATION

(71) Applicant: Beijing Zitiao Network Technology Co., Ltd., Haidian District, Beijing (CN)

(72) Inventor: Pengxiang Yan, Beijing (CN)

(21) Appl. No.: 19/130,294

(22) PCT Filed: Nov. 8, 2023
(86) PCT No.: PCT/CN2023/130577

§ 371 Date: May 15, 2025

(30) Foreign Application Priority Data
Nov. 15, 2022 (CN) 202211430306.1

(51) Int. Cl. G06V 20/40; G06T 7/20; G06V 10/26; G06V 10/764

(52) U.S. Cl. CPC G06V 20/41; G06T 7/20; G06V 10/26; G06V 20/46; G06V 20/49; G06T 2207/10016; G06V 10/764

(57) ABSTRACT

The embodiment of the invention provides a method, apparatus, device, medium and product of video annotation, and the method includes: determining a sub-segment to be annotated in a video to be annotated to obtain a target sub-segment; obtaining a first frame annotation result corresponding to a first frame of the target sub-segment; generating an end frame annotation result corresponding to an end frame of the target sub-segment based on the first frame annotation result; generating an annotation result of an intermediate frame of the target sub-segment based on the first frame annotation result and the end frame annotation result, to obtain an annotation result of the target sub-segment to be annotated; and generating a target annotation result of the video to be annotated based on the annotation result of the target sub-segment.

This application claims priority to Chinese Patent Application No. 202211430306.1, entitled “Method, Apparatus, Device, Medium and Product of Video Annotation” filed on Nov. 15, 2022, the entire contents of which are incorporated herein by reference.

### FIELD

The embodiment of the present disclosure relates to the technical field of computers, in particular to a method, apparatus, device, medium and product of video annotation.

### BACKGROUND

Video processing may be applied to many technical fields such as artificial intelligence, intelligent transportation, finance, content recommendation, etc., and specifically related technologies may include, for example, target tracking, target detection, and the like.

In the related art, the annotation of the video is usually manually annotated on a frame-by-frame basis. However, for the manner of adopting manual annotation, the annotation efficiency is relatively low, and the annotation cost is too high.

### SUMMARY

The embodiment of the present disclosure provides a method, apparatus, device, medium and product of video annotation, so as to overcome the technical problems that, for the manner of adopting manual annotation, the annotation efficiency is relatively low, and the annotation cost is too high.

According to a first aspect, embodiments of the present disclosure provide a method of video annotation, comprising:
determining a sub-segment to be annotated in a video to be annotated to obtain a target sub-segment;
obtaining a first frame annotation result corresponding to a first frame of the target sub-segment;
generating an end frame annotation result corresponding to an end frame of the target sub-segment based on the first frame annotation result;
generating an annotation result of an intermediate frame of the target sub-segment based on the first frame annotation result and the end frame annotation result, to obtain an annotation result of the target sub-segment to be annotated;
generating a target annotation result of the video to be annotated based on the annotation result of the target sub-segment.

According to a second aspect, embodiments of the present disclosure provide an apparatus for video annotation, comprising:
a first determining unit, configured to determine a sub-segment to be annotated in a video to be annotated to obtain a target sub-segment; and
a first frame annotation unit, configured to obtain a first frame annotation result corresponding to a first frame of the target sub-segment;
an end frame annotation unit, configured to generate an end frame annotation result corresponding to an end frame of the target sub-segment based on the first frame annotation result;
a segment annotation unit, configured to generate an annotation result of an intermediate frame of the target sub-segment based on the first frame annotation result and the end frame annotation result, to obtain an annotation result of the target sub-segment to be annotated;
a second determining unit, configured to generate a target annotation result of the video to be annotated based on the annotation result of the target sub-segment.

According to a third aspect, embodiments of the present disclosure provide an electronic device, comprising: a processor and a memory;
the memory storing computer-executable instructions;
the processor executing the computer-executable instructions stored in the memory, such that the processor is configured with the method of video annotation according to the first aspect and various possible designs of the first aspect.

According to a fourth aspect, embodiments of the present disclosure provide a computer-readable storage medium, the computer-readable storage medium storing computer-executable instructions, a processor, when executing computer-executable instructions, implementing the method of video annotation according to the first aspect and the possible designs of the first aspect.

According to a fifth aspect, embodiments of the present disclosure provide a computer program product, comprising a computer program, wherein when the computer program is executed by a processor, the processor implements the method of video annotation according to the first aspect and various possible designs of the first aspect.

According to the technical solution provided in this embodiment, for the video to be annotated, the target sub-segment to be annotated may be determined from the segment dimension. When the target sub-segment is annotated in detail, the first frame annotation result corresponding to the first frame of the target sub-segment may be first obtained, then the end frame annotation result corresponding to the end frame of the target sub-segment is generated based on the first frame annotation result, and the intermediate frame in the target sub-segment may be annotated with the first frame annotation result and the end frame annotation result, so as to annotate the intermediate frame of the target sub-segment to obtain the annotation result of the target sub-segment. The end frame may be obtained through automatic annotation of the first frame, and the intermediate frame may be automatically annotated by using the first frame annotation result and the end frame annotation result, to implement efficient annotation of the intermediate frame. After the annotation result of the target sub-segment is obtained, the target annotation result of the video to be annotated may be determined, the accuracy of the segment annotation may be improved through the segment annotation with smaller time dimension, compared with directly annotating the video to be annotated, the efficiency is higher, and the accuracy is higher.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application example diagram of a method of video annotation according to an embodiment of the present disclosure;

FIG. 2 is a flowchart of a method of video annotation according to an embodiment of the present disclosure;

FIG. 3 is a flowchart of still another embodiment of a method of video annotation according to an embodiment of the present disclosure;

FIG. 4 is an example diagram of feature propagation according to an embodiment of the present disclosure;

FIG. 5 is a flowchart of still another embodiment of a method of video annotation according to an embodiment of the present disclosure;

FIG. 6 is an updated example diagram of a first frame annotation result according to an embodiment of the present disclosure;

FIG. 7 is a flowchart of still another embodiment of a method of video annotation according to an embodiment of the present disclosure;

FIG. 8 is a flowchart of still another embodiment of a method of video annotation according to an embodiment of the present disclosure;

FIG. 9 is an example diagram of a division of a video sub-segment according to an embodiment of the present disclosure;

FIG. 10 is an example diagram of an extract of a key frame according to an embodiment of the present disclosure;

FIG. 11 is a schematic structural diagram of an embodiment of an apparatus for video annotation according to an embodiment of the present disclosure;

FIG. 12 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. All other embodiments obtained by those skilled in the art based on the embodiments of the present disclosure without creative efforts shall fall within the scope of the present disclosure.

According to the technical scheme, the method can be applied to the video annotation scene. By obtaining the first frame annotation result, the end frame is automatically annotated through the first frame annotation result, the other image frames in the image frames may be automatically annotated through the obtaining of the first frame annotation result and the end frame annotation result, and the annotation efficiency of the video is improved.

In the related art, training of a video processing model requires a large amount of video samples. The video samples may include the video itself as well as labels of the video. The label of the video may generally refer to labels of each image frame in the video, each video frame, that is, the annotation result of each image frame in the video is generally obtained through manual annotation. The manual annotation is generally required to be manually completed frame by frame, which requires a large amount of labor, the annotation efficiency is relatively low, and the annotation cost is relatively high.

In order to solve the problem of the cost of manual annotation being too high, the present disclosure contemplates automatically completing the annotation of an image. The automatic annotation of the image generally requires a region recognition model of the image, and if the region recognition model is directly used, the obtained annotation result is not accurate enough. In order to obtain an accurate annotation result, manually annotating part of the image may be applied, then the remaining image is annotated with a manually annotated image through applying a semi-supervised annotation manner. The accuracy of the images annotated through this manner is higher, and the annotation efficiency is also greatly improved.

The technical solutions of the present disclosure and how the technical solutions of the present disclosure can solve the above technical problem will be described in detail below with reference to specific embodiments. The following specific embodiments may be combined with each other, and the same or similar concepts or processes may be omitted in some embodiments. Embodiments of the present invention will be described in detail below with reference to the accompanying drawings.

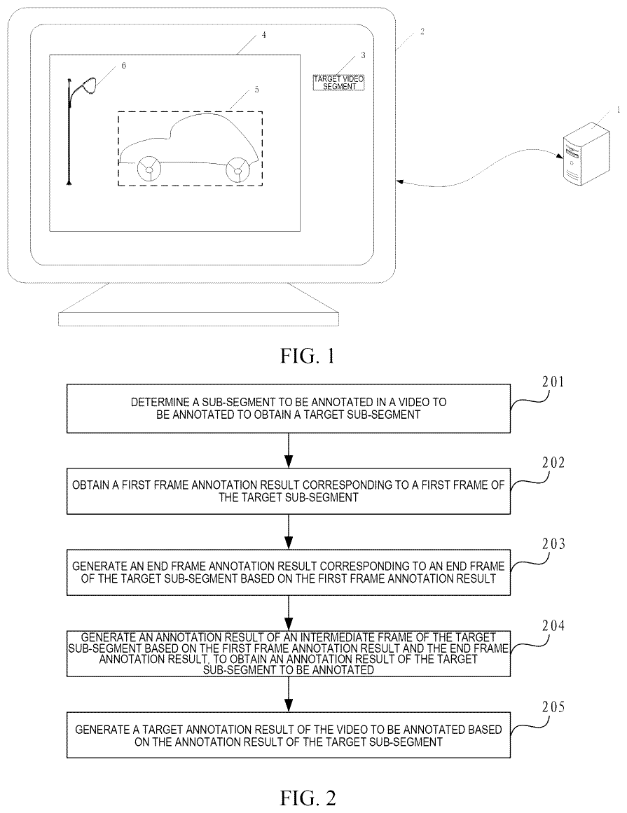

FIG. 1 is an application example diagram of a method of video annotation according to an embodiment of the present disclosure. The method of video annotation may be applied to the electronic device 1. The electronic device 1 may comprise a display apparatus 2. The display apparatus 2 may display a video to be annotated. The video to be annotated may be divided into at least one video sub-segment based on the plurality of key frames. According to the technical solution of the present disclosure, the video to be annotated may be annotated according to each video sub-segment, for example, segment annotation is performed on the target sub-segment 3, the electronic device 1 may display the segment annotation result of any image 4 in the target sub-segment 3 in the display apparatus 2. The segment annotation result may be, for example, the area 5 where the vehicle is located in FIG. 1, and other types of objects in the image, for example, the street lamp 6 may not be annotated, to obtain the segment annotation result of the image 4. Wherein, for ease of understanding, the vehicle area 5 shown in FIG. 1 is annotated with a rectangular box, the annotation manner is merely exemplary, and should not constitute a specific limitation on the annotation manner and the annotation type. In practical application, the annotation may be performed using the outline of the annotated object, a circular shape, a polygon and other shapes and the like. After the segment annotation result is determined, the target annotation result of the video to be annotated may be determined by using the annotated target sub-segment.

As shown in FIG. 2, FIG. 2 is a flowchart of an embodiment of a method of video annotation according to an embodiment of the present disclosure.
201: determine a sub-segment to be annotated in a video to be annotated to obtain a target sub-segment.

Optionally, before determining a sub-segment to be annotated in a video to be annotated to obtain a target sub-segment, the method may further include: obtaining a video to be annotated, in response to the video annotation request.

The target sub-segment may be a sub-segment to be annotated in at least one video sub-segment in the video to be annotated. The video to be annotated may be divided into at least one video sub-segment, and the at least one video sub-segment may be obtained by dividing the video segment to be annotated.
202: obtain a first frame annotation result corresponding to a first frame of the target sub-segment.

The first frame may be the first image of the target sub-segment, or may be any image of the target sub-segment.

The first frame annotation result may be obtained through manual annotation, or may be obtained through image annotation model extraction. In order to improve the first frame annotation efficiency, the automatic annotation may be performed through the image annotation model, and then the annotation result of the image annotation model is corrected manually to obtain a final first frame annotation result.

The end frame may be the last image of the target sub-segment.
203: generate an end frame annotation result corresponding to an end frame of the target sub-segment based on the first frame annotation result.

The end frame annotation result may be obtained by using the annotation result of the first image of the target sub-segment in combination with the semi-supervised annotation algorithm. The semi-supervised annotation algorithm may apply a forward propagation manner to propagate an annotation result of the first image of the target sub-segment to the end frame, to obtain an end frame annotation result of the end frame.
204: generate an annotation result of an intermediate frame of the target sub-segment based on the first frame annotation result and the end frame annotation result, to obtain an annotation result of the target sub-segment to be annotated.

The intermediate frame may include an unannotated image frame in the target sub-segment, and the intermediate frame may be obtained through the first frame annotation result and the end frame annotation result. The target sub-segment may include a plurality of images or image frames, and each image may be annotated to obtain a annotation result of each image. After the plurality of image frames in the target sub-segment are all annotated, a segment annotation result of the target sub-segment formed by the annotation results respectively corresponding to the plurality of image frames of the target sub-segment may be obtained.
204: generate a target annotation result of the video to be annotated based on the annotation result of the target sub-segment.

The video to be annotated may include at least one video sub-segment, and during the annotation process, each video sub-segment may be referred to as a target sub-segment. The annotation result of the target sub-segment may be obtained after the annotation is finished. The target annotation result of the video to be annotated may include annotation results respectively corresponding to the plurality of video subsegments.

In the embodiments of the present disclosure, for the video to be annotated, the segment to be annotated may be determined from the segment dimensions to obtain the target sub-segment. In the annotation for the target sub-segment, the first frame annotation result corresponding to the first frame of the target sub-segment may be first obtained, and the end frame annotation result corresponding to the end frame is generated by using the first frame annotation result of the first frame, and the intermediate frames in the target sub-segment may be respectively annotated with the first frame annotation result and the end frame annotation result, to implement the automatic annotation for the target sub-segment to obtain the annotation result of the target sub-segment. Each image in the target sub-segment may be automatically annotated by using the first frame annotation result and the end frame annotation result, to obtain an efficient annotation effect. After obtaining the segment annotation result of the target sub-segment, the target annotation result of the video to be annotated may be determined, the segment annotation efficiency may be improved through the segment annotation with smaller time dimension, and compared with annotating the video to be annotated directly, the accuracy is higher.

In general, the end frame annotation result of the end frame may be obtained by applying a manual annotation manner. However, in order to improve the annotation efficiency of the end frame, the forward propagation algorithm may be used to determine the end frame annotation result of the end frame.

As shown in FIG. 3, FIG. 3 is a flowchart of an image annotation method according to an embodiment of the present disclosure.
301: obtain the first frame annotation result corresponding to the first frame of the target sub-segment.
302: determine, based on the first frame annotation result, the end frame annotation result corresponding to the end frame with a forward propagation algorithm.

In the embodiments of the present disclosure, the end frame annotation result of the end frame may be automatically determined according to the first frame annotation result and in combination with the forward propagation algorithm. By automatically determining the end frame annotation result of the end frame, the annotation efficiency of the end frame may be effectively improved.

In a possible design, determining the end frame annotation result corresponding to the end frame with the forward propagation algorithm according to the first frame annotation result comprises:
performing, with the forward propagation algorithm, a sequential propagation of annotation result for the first frame annotation result to an unannotated image frame in the target sub-segment, to obtain an annotation result of the unannotated image frame in the target sub-segment;
obtaining an annotation result of a last image frame of the target sub-segment as the end frame annotation result corresponding to the end frame.

In the embodiments of the present disclosure, with the forward propagation algorithm, a sequential propagation of annotation result for the first frame annotation result to an unannotated image frame in the target sub-segment is performed, to obtain an annotation result of the unannotated image frame. Through propagating the first frame annotation result to the unannotated image frame until it is propagated to the last image frame of the target video segment with the forward propagation algorithm, an end frame annotation result corresponding to the end frame is obtained. Through the propagation of the annotation result, the annotation of the end frame is propagated and obtained continuously, so that the annotation of the end frame references its neighboring, for example, the annotation result of a previous image frame of the end frame, improving the annotation efficiency and accuracy of the end frame.

In practical applications, a bidirectional propagation manner may be used to annotate the intermediate frame of the target sub-segment. For the intermediate frame at different positions, the image may be automatically annotated according to the difference between the positions of the intermediate frame and the first frame and the end frame respectively, so as to improve the annotation precision of the image.

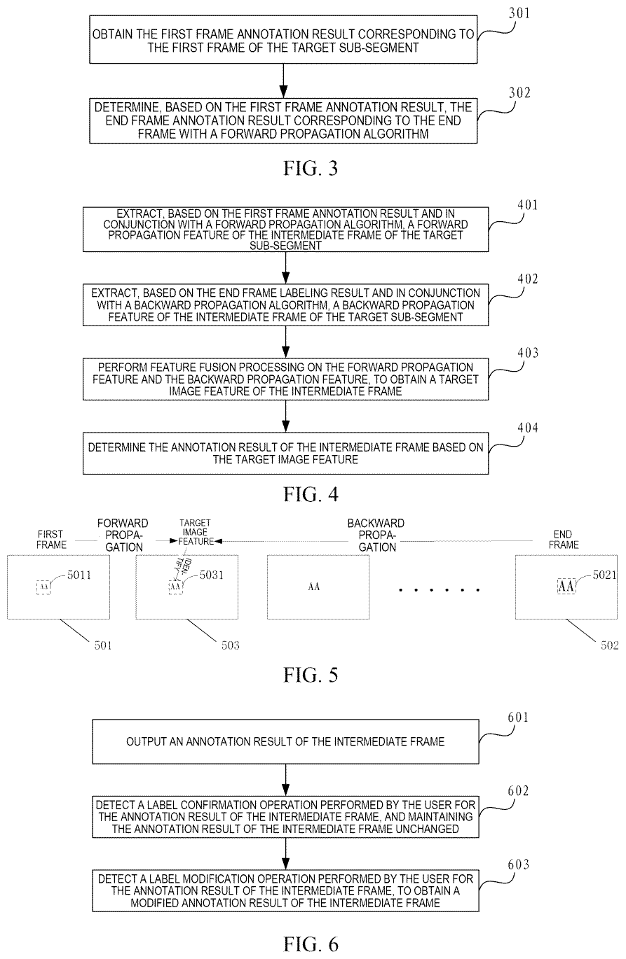

Therefore, as shown in FIG. 4, FIG. 4 is a flowchart of another embodiment of a method of video annotation according to an embodiment of the present disclosure. What is different from the foregoing embodiments is that: generating the annotation result of the intermediate frame of the target sub-segment based on the first frame annotation result and the end frame annotation result comprises:
401: extract, based on the first frame annotation result and in conjunction with a forward propagation algorithm, a forward propagation feature of the intermediate frame of the target sub-segment.

Optionally, the forward propagation algorithm may include an algorithm such as a machine learning algorithm or a neural network algorithm, and may be obtained through training. The forward propagation algorithm may be configured to perform feature propagation on the first frame annotation result of the first frame to the intermediate frame located after the first frame, to obtain the forward propagation feature of the intermediate frame.

The target sub-segment may include N image frames, and each image frame may be annotated as an intermediate frame. N is a positive integer greater than 1. The first frame and the end frame may be annotated first, and then each image frame may be sequentially used as an intermediate frame starting from the second image frame in the target sub-segment to obtain an annotation result of each intermediate frame, until an annotation result of the previous image of the end frame of the target sub-segment is obtained, and at this time, the annotation of the target sub-segment ends.

Wherein, the forward propagation feature may refer to an image feature obtained by performing feature propagation on a label of a first frame starting from a first frame to another image located after the first frame, and propagating to an image corresponding to an image sequence number, then stop the propagation. The first frame annotation result is used as a feature propagation mask to participate in the feature calculation. Specifically, the feature transmission may be performed by using the semi-supervised segmentation algorithm in the following embodiments.
402: extract, based on the end frame labeling result and in conjunction with a backward propagation algorithm, a backward propagation feature of the intermediate frame of the target sub-segment.

Optionally, the backward propagation algorithm may include an algorithm such as a machine learning algorithm or a neural network algorithm, and may be obtained by training. The backward propagation algorithm may propagate the end frame annotation result to the intermediate frame before the end frame to obtain the backward propagation feature of the intermediate frame.

Wherein, the backward propagation feature may refer to an image feature obtained by performing feature propagation, frame by frame, on a label of an end frame to another image located before the end frame, and propagating to an image corresponding to an image sequence number, then stop the propagation. Similarly, the end frame annotation result may also be used as a feature propagation mask to participate in the feature calculation.
403: perform feature fusion processing on the forward propagation feature and the backward propagation feature, to obtain a target image feature of the intermediate frame.
404: determine the annotation result of the intermediate frame based on the target image feature.

The target sub-segment may comprise one or more intermediate frames, and each intermediate frame may be annotated to obtain an annotation result of each intermediate frame. The segment annotation result of the target sub-segment may include a annotation result of each of the plurality of intermediate frames.

In the embodiments of the present disclosure, the forward propagation feature of the intermediate frame may be obtained with the forward propagation algorithm, and the backward propagation feature of the intermediate frame may be obtained with the backward propagation algorithm. The fusion of the forward propagation feature and the backward propagation feature may enable the target image feature to fuse the first frame annotation result and the end frame annotation result, the annotation feature of the intermediate frame may be better represented through the target image feature, and the annotation precision and accuracy of the intermediate frame are improved.

In an embodiment, the extraction step of the forward propagation feature may comprise: determining the forward propagation feature of the intermediate frame with a forward propagation algorithm according to the first frame annotation result and the image sequence number. The extraction step of the backward propagation feature may comprise: determining a backward propagation feature of the intermediate frame with a backward propagation algorithm according to the end frame annotation result and the image sequence number.

In practical applications, labeling the image may comprise setting different categories according to different actual usage requirements. A plurality of categories of labels may be labeled at once. For example, in a natural image processing scenario, target tracking may be performed on vehicles and pedestrians in a video. Thus, the vehicles and pedestrians may be set as two label categories, and the labeling may be performed respectively. In the image feature extraction process, in order to better represent labels of different categories, and labels of various categories are not affected by other categories, label features may be separately generated for each label category. An element of the label feature may represent a probability that each pixel belongs to the label category. For a same coordinate, an element value of the coordinate may specifically include a probability value corresponding to the coordinate in at least one label category, and a label represented by a label category with a largest probability value is a label of the coordinate.

In a possible design, after obtaining the forward propagation feature and the backward propagation feature, a feature fusion processing may be performed on the forward propagation feature and the backward propagation feature to obtain a target image feature of the intermediate frame; and the annotation result of the intermediate frame may be determined by feature recognition based on the target image feature. Determining the forward propagation feature of the intermediate frame according to the first frame annotation result and the image sequence number comprises: performing feature extraction on the first frame according to the first frame annotation result to obtain label features respectively corresponding to the first frame in the at least one label category, and propagating the label feature corresponding to the at least one label category corresponding to the first frame back to obtain the forward label features respectively corresponding to the intermediate frame in the at least one label category, so as to obtain forward propagation features respectively corresponding to the at least one label category.

Optionally, the determining a backward propagation feature of the intermediate frame based on the end frame annotation result and the image sequence number includes: performing feature extraction on the end frame according to the end frame label to obtain label features corresponding to the end frame in at least one label category, and propagating label features corresponding to the at least one label category corresponding to the end frame forward to obtain backward label features respectively corresponding to the at least one label category of the intermediate frame, to obtain forward propagation features respectively corresponding to the at least one label category.

In the embodiments of the present disclosure, the forward propagation feature is obtained based on the first frame annotation result and the image sequence number, so that the forward propagation feature integrates the characteristic of the first frame annotation result and the image sequence number. Then, the backward propagation feature is obtained based on the end frame annotation result and the image sequence number, and the characteristic of the end frame annotation result and the image sequence number are integrated. The forward propagation feature and the backward propagation feature are the results obtained by the propagation of the image feature from the first frame and the propagation of the image feature from the end frame, respectively. Performing feature fusion processing with the forward propagation feature and the backward propagation feature to obtain a target image feature of the intermediate frame. The target image feature integrates the propagation characteristic of the forward and backward directions, the annotation result obtained with the target image feature is more accurate, and the annotation efficiency and accuracy of the intermediate frame can be improved.

In a possible design, the forward propagation algorithm may include: a semi-supervised segmentation algorithm.

The backward propagation algorithm may include: a semi-supervised segmentation algorithm.

The forward feature propagation may be performed, frame by frame, on the target sub-segment from the first frame with a semi-supervised segmentation algorithm according to the first frame annotation result until the forward propagation feature at the image sequence number is obtained. According to the end frame annotation result, the semi-supervised segmentation algorithm is used to perform, frame by frame, backward feature propagation processing on the target sub-segment from the end frame until the backward propagation feature at the image sequence number is obtained.

Wherein, the semi-supervised segmentation algorithm may be specifically a semi-supervised object segmentation algorithm. The image feature of the current frame may be calculated, for the target sub-segment, by using the image feature of the previous frame starting from the first frame or the end frame through a semi-supervised segmentation algorithm. Until the forward propagation feature or backward propagation feature corresponding to the image sequence number are obtained.

In the embodiments of the present disclosure, forward feature propagation may be performed, frame by frame, on the target sub-segment from the first frame through the semi-supervised segmentation algorithm, until the forward propagation feature at the image sequence number location is obtained. With the semi-supervised segmentation algorithm, forward propagation of image features can be completed, so that the forward propagation feature obtained through calculation are integrated with the forward features of the first frame and the previous image of itself, and the expression level of the features is higher through the semi-supervised segmentation algorithm, and the feature can also be propagated from the end frame, that is, the backward feature propagation processing is performed frame by frame starting from the end frame until the backward propagation feature at the image sequence number is obtained. Through the semi-supervised segmentation algorithm, forward or backward propagation can be performed on the image feature, and the calculation accuracy of the image features is improved.

After obtaining the forward propagation feature and the backward propagation feature, the fusion calculation of the feature may be performed based on the forward propagation feature and the backward propagation feature, so that the image feature of the intermediate frame integrates the feature of the forward aspect and the backward aspect. In some embodiments, performing feature fusion processing on the forward propagation feature and the backward propagation feature to obtain the target image feature of the intermediate frame comprises:
determining an image sequence number of the intermediate frame in the target sub-segment;
determining a sequence number ratio based on the image sequence number;
determining a forward propagation weight and a backward propagation weight based on the sequence number ratio;
obtaining the target image feature of the intermediate frame based on the forward propagation weight, the backward propagation weight, the forward propagation feature and the backward propagation feature.

Optionally, the image sequence number of the intermediate frame may refer to an occurrence sequence of the intermediate frame in the target sub-segment in the target sub-segment. For example, the image sequence number of the first image in the target sub-segment may be 1, and the image sequence number of the second appearing graphic may be 2. The position of the intermediate frame in the target sub-segment may be determined through the image sequence number. The corresponding image sequence number of each image frame may be determined according to its annotation sequence. For example, the image sequence number of the first frame may be 1, and the image sequence number of the end frame may be N+1.

In this embodiment of the present disclosure, the intermediate frame in the target sub-segment and the image sequence number of the intermediate frame may be determined, and the sequence number of the intermediate frame may represent the positional relationship between the intermediate frame and the first frame and the last frame. The annotation result of the intermediate frame may be determined through the first frame annotation result and the end frame annotation result in combination with the image sequence number of the intermediate frame. Such that, the annotation effect of the intermediate frame is associated with the position of the intermediate frame in the target sub-segment, and the annotation accuracy is improved.

In one embodiment, determining the sequence number ratio based on the image sequence number may include:
calculating a sequence number ratio between the image sequence number of the intermediate frame and the end frame sequence number corresponding to the end frame of the target sub-segment.

In another embodiment, obtaining the target image feature of the intermediate frame according to the forward propagation weight, the backward propagation weight, the forward propagation feature, and the backward propagation feature may include:
performing feature fusion processing weighted summation on the forward propagation feature and the backward propagation feature according to the forward propagation weight and the backward propagation weight to obtain the target image feature of the intermediate frame.

The image sequence number is K, the sequence number of the end frame is N, and the sequence number ratio is K/N. Determining the forward propagation weight and the backward propagation weight based on the sequence number ratio may include: determining that the sequence number ratio K/N is the backward propagation weight, and determining a difference between the integer 1 and the sequence number ratio, that is, 1−K/N, which is the forward propagation weight. The weighted summation step of the target image feature may include:

Calculating the product of the forward propagation weight: 1−K/N and the forward propagation feature F_{forward} to obtain a first feature; calculating a product of the backward propagation weight: K/N and the backward propagation feature F_{backward} to obtain a second feature; and adding the first feature and the second feature to obtain the target image feature F_{current}.

Optionally, the forward propagation feature may include forward label features corresponding to at least one label category. The backward propagation feature may include a backward label feature corresponding to at least one label category. Performing weighted summation on the forward label feature and the backward label feature of each label category according to the forward propagation weight and the backward propagation weight, to obtain a fusion feature corresponding to each label category. The fusion feature corresponding to each label category is the target image feature.

The weighted summation of the forward label feature and the backward label feature of each label category may include: for the forward label feature and the backward label feature of each label category, multiplying the first feature value of the forward label feature and the forward propagation weight of each pixel coordinate, multiplying the second value of the backward label feature and the backward propagation weight, and adding the two products to obtain the feature value of each pixel coordinate in the label category, that is, obtaining the feature value of the label category at each pixel coordinate.

The target image feature may be represented as a feature value of each pixel coordinate of the intermediate frame in different label categories.

For ease of understanding, as shown in the feature propagation example diagram shown in FIG. 5, it is assumed that the first frame annotation result of the first frame 501 is 5011, and the end frame annotation result of the end frame 502 is 5021. Wherein, the first frame annotation result 5011 of the first frame 501 forward propagates the corresponding forward propagation feature, and the end frame annotation result 5021 of the end frame 502 backward propagates the feature correspondingly. The intermediate frame 503 may perform feature fusion on the forward propagation feature and the backward propagation feature based on its sequence number to obtain a corresponding target image feature. The target image feature is identified by the image classification layer to obtain a target area 5031 of the intermediate frame. The target area 5031 may be an annotation result of the intermediate frame.

In the embodiments of the present disclosure, the association level between the image and the forward propagation feature and the backward propagation feature may be calculated based on the image sequence number, that is, the sequence number ratio corresponding to the image sequence number is calculated. The sequence number ratio may be used to determine the forward propagation weight and the backward propagation weight. Through calculation of the associated characteristic of forward propagation and backward propagation, the propagation efficiency of the image may be improved accurately, and the accuracy of image feature propagation is improved.

In an embodiment, determining the annotation result of the intermediate frame according to the target image feature may include:
identifying a target area of the target image feature according to the image classification layer;
the target area is used as an annotation result of the intermediate frame.

Optionally, identifying the target area of the target image feature according to the image classification layer may include: determining feature values respectively corresponding to each pixel coordinate of the intermediate frame in the target image feature in the at least one label category, and obtaining a maximum feature value of each pixel coordinate in the feature values respectively corresponding to the at least one label category, to obtain a maximum feature value of each pixel coordinate. Determining a target pixel coordinate corresponding to each label category according to the label category corresponding to the maximum feature value of each pixel coordinate, determining a label area formed by the target pixel coordinate of each label category, and obtaining a target area constructed by the label area corresponding to the at least one label category. That is, the label area corresponding to the at least one label category may be the annotation result of the intermediate frame. The image classification layer may be a mathematical model for performing feature classification on the image features.

In the embodiments of the present disclosure, after the annotation result of the intermediate frame is determined, the target area of the target image feature may be identified according to the image classification layer, and the target area is used as the annotation result of the intermediate frame. Accurate label extraction can be performed on the target image feature by using the image classification layer.

As shown in FIG. 6, FIG. 6 is a flowchart of another embodiment of a method of image annotation according to an embodiment of the present disclosure.
601: output an annotation result of the intermediate frame.

The annotation result may include label areas respectively corresponding to at least one label category.
602: detect a label confirmation operation performed by the user for the annotation result of the intermediate frame, and maintaining the annotation result of the intermediate frame unchanged.
603: detect a label modification operation performed by the user for the annotation result of the intermediate frame, to obtain a modified annotation result of the intermediate frame.

The intermediate frame and the annotation result thereof may be output simultaneously, and the automatic annotation result of the intermediate frame is output for the user to view.

In the embodiment of the present disclosure, after the annotation result of the intermediate frame is output, the user may view the annotation result of the intermediate frame, and view the labeling effect of the annotation result, if the labeling is not qualified, the annotation result may be modified, and if the labeling is qualified, the annotation result of the intermediate frame may be directly determined. By interacting with the user, the annotation result of the intermediate frame may be more matched with the annotation requirement of the user, and the annotation accuracy is higher.

In an embodiment, obtaining the first frame annotation result corresponding to the first frame of the target sub-segment may comprise:
detecting an annotation operation performed by a user for the first frame, to obtain the first frame annotation result corresponding to the annotation operation.

Or, obtaining a previous video sub-segment of the target sub-segment, and determining an end frame annotation result corresponding to an end frame of the previous video sub-segment as the first frame annotation result corresponding to the first frame of the target sub-segment.

Optionally, when the first frame is the first image of the target sub-segment and the target sub-segment is the first video sub-segment of the video to be annotated, the label setting operation performed by the user for the first frame of the target sub-segment may be detected, to obtain the first frame annotation result at the end of the setting. Alternatively, when the target sub-segment is not the first video sub-segment, the end frame annotation result of the end frame of the previous video sub-segment of the target sub-segment is obtained as the first frame annotation result corresponding to the first frame of the target sub-segment.

In the embodiment of the present disclosure, the first frame annotation result corresponding to the annotation operation may be obtained by detecting the annotation operation performed by the user for the first frame, the first frame annotation result which is more matched with the user annotation requirement may be obtained, or the end frame annotation result of the previous video sub-segment may be used as the annotation result of the first frame, so that the first frame annotation efficiency may be improved.

In another embodiment, in addition to the technical solutions provided in the foregoing embodiments, the obtaining manner of the first frame annotation result corresponding to the first frame, the first frame of the target sub-segment and the first frame annotation result corresponding to the first frame may be obtained in the following manner:
if the label modification operation is performed by the user for the annotation result of the intermediate frame, update the intermediate frame after the modification of the annotation result to be the first frame;
the modified annotation result of the intermediate frame is used as the first frame annotation result.

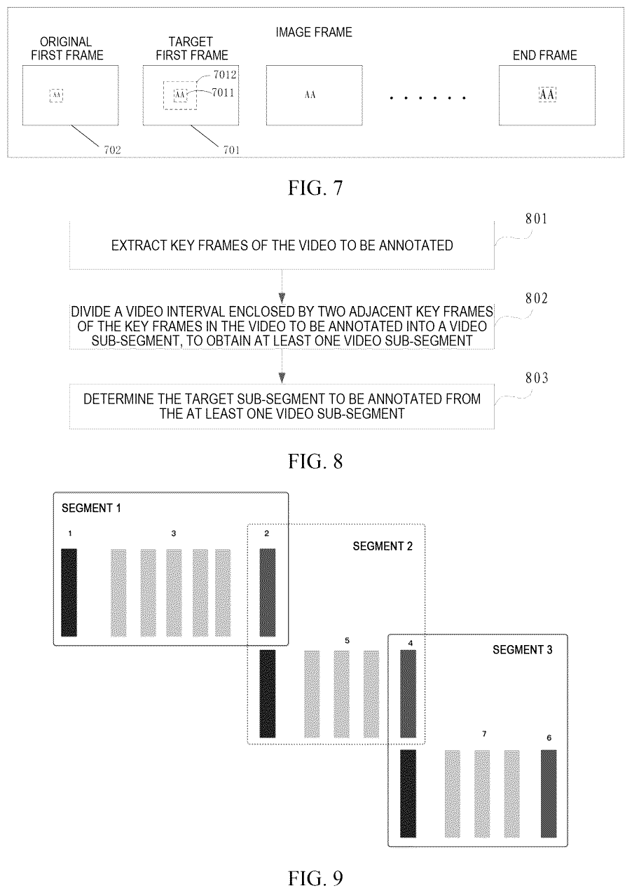

As shown in FIG. 7, FIG. 7 is an example diagram of an annotation prompt of an image frame according to an embodiment of the present disclosure. Referring to FIG. 7, after obtaining the annotation result 7011 of the intermediate frame 701, if it is detected that the user modifies the annotation result of the intermediate frame to the annotation result 7012, for example, the intermediate frame 701 may be used as the first frame. While, the original frame 702 may no longer be used as the first frame. Of course, the annotation prompt of the image frame of FIG. 7 is merely exemplary and does not have a limitation function.

In the embodiment of the present disclosure, when the user performs the label modification operation on the intermediate frame, it means that the propagation precision of the label is reduced, and the matching level with the actual annotation requirement of the user is low. The intermediate frame after modifying the label is used as the first frame, the modified image annotation of the intermediate frame is used as the first frame annotation result, more effective image propagation may be provided, and the propagation efficiency and accuracy of the image are improved.

In order to obtain an accurate video sub-segment, as shown in FIG. 8, FIG. 8 is a flowchart of another embodiment of a method of video annotation according to an embodiment of the present disclosure. What is different from the previous embodiments is that, determining the sub-segment to be annotated in the video to be annotated to obtain the target sub-segment, comprises:
801: extract key frames of the video to be annotated.
802: divide a video interval enclosed by two adjacent key frames of the key frames in the video to be annotated into a video sub-segment, to obtain at least one video sub-segment.
803: determine the target sub-segment to be annotated from the at least one video sub-segment.

Optionally, the key frames of the video to be annotated may be grouped in a group manner, and two adjacent key frames may be used as a group, and at least one group of key frames may be determined from the at least one key frame. The group of key frames includes a first key frame and a second key frame adjacent to each other, the first key frame is located before the second key frame, and the second key frame of the previous group of key frames is the same as the first key frame of the next group of key frames. A video interval enclosed by two adjacent key frames may be used as a video sub-segment, that is, the video sub-segment may include two key frames and intermediate frames between the two key frames, and certainly, the intermediate frame may be obtained by sampling according to a predetermined sampling frequency.

Wherein, the key frame may be an image with a larger difference from the image near the key frame in the video to be annotated. For example, if there is no vehicle in the image at the time t1, and there is a vehicle appearing in the image at the time t2, and the time difference between the t1 and the t2 is within the time constraint, then the image at the time t2 is determined as the key frame.

For ease of understanding, FIG. 9 is an example diagram of the division of a video sub-segment according to an embodiment of the present disclosure. Referring to FIG. 9, the key frames of the video to be annotated are key frame 1, key frame 2, key frame 4, and key frame 6, respectively. Two adjacent key frames may be used as a group.

The key frame 1 and the key frame 2 may be used as a group of adjacent key frames, and image frames enclosed by the group of adjacent key frames may be a video sub-segment 1. Video sub-segment 1 may consist of key frame 1, key frame 2, and image frame 3 between key frame 1 and 2.

The key frame 2 and the key frame 4 may be used as a group of adjacent key frames, and image frames enclosed by the group of adjacent key frames may be a video sub-segment 2. Video sub-segment 2 may consist of key frame 2, key frame 4, and image frame 5 between key frame 2 and 4.

The key frame 4 and the key frame 6 may be used as a group of adjacent key frames, and image frames enclosed by the group of adjacent key frames may be a video sub-segment 3. Video sub-segment 3 may consist of key frame 4, key frame 6, and image frame 7 between key frame 4 and 6.

The key frames of two adjacent key frames overlap, referring to FIG. 9, the key frame 2 may be an end frame of the video sub-segment 1, and the key frame 2 may also be a first frame of the video sub-segment 2. The key frame 4 may be an end frame of the video sub-segment 2, and may be a first frame of the video sub-segment 3. Extraction of each key frame are performed through the extraction manner of this key frame.

In the embodiments of the present disclosure, by extracting the key frame of the video to be annotated, obtaining of two adjacent key frames may be completed based on the key frame. The video interval enclosed by two adjacent key frames in the video to be annotated may be one video sub-segment, and then at least one video sub-segment corresponding to the video to be annotated is obtained, such that the last frame of the previous video sub-segment of two adjacent video sub-segments in the at least one video sub-segment is the same as the first frame of the next video sub-segment, which completes an accurate and comprehensive segmentation of the video to be annotated, such that the segmentation efficiency of the at least one video sub-segment is higher.

In some embodiments, at least one key frame may be extracted from the video to be annotated according to the key frame extraction frequency; or at least one key frame satisfying the image change condition may be extracted from the video to be annotated.

The key frame extraction frequency may be set according to usage requirements, which may be preset. The unit of the key frame extraction frequency is frame/time. Each interval features extraction frequency of image frames, a key frame is extracted. For example, when the key frame extraction frequency is 10, one key frame may be extracted every 10 frames, and the 1^{st} frame and the 11^{th} frame may be a key frame.

In a possible design, extracting at least one key frame of the video to be annotated comprises:
for image frames in the video to be annotated, calculating a motion amplitude value of each image frame;
obtaining the at least one key frame in the image frame based on the motion amplitude value.

The image change condition may include that a motion amplitude value of the image frame is greater than an metric threshold.

Optionally, obtaining at least one key frame in the image frames based on the motion amplitude value may comprise:

If the motion amplitude value of any image frame is greater than the metric threshold, then the image frame is determined as a key frame to obtain at least one key frame of the plurality of image frames.

The motion amplitude value may refer to an amplitude difference between the image frame and its surrounding frame. A difference calculation may be performed between the amplitude value of the image frame and the amplitude value of its surrounding frame to obtain the motion amplitude value. If the motion amplitude value is greater than the metric threshold, it indicates that the difference between the image frame and its surrounding frame is relatively large, and the image frame may be used as a key frame.

For ease of understanding, FIG. 10 is an example diagram of the extraction a key frame according to an embodiment of the present disclosure. Taking the vertical axis is the motion amplitude value of each image frame and the horizontal axis is the sequence number of each image frame in the video to be annotated as an example, the amplitude value of each image frame is continuously changing starting from the first image frame 0, and the connection line of the amplitude values of each image frame forms a curve 1001. The motion amplitude value may be an amplitude value difference between image frames. The variation states of the curve 1001 may determine the amplitude value difference of the image frame, that is, the image frame corresponding to the key point 1002 with the previous and next motion amplitude values greater than the metric threshold may be a key frame.

In the embodiment of the present disclosure, the metric data of each image frame in the motion amplitude metric may be calculated for the plurality of image frames in the video to be annotated, and the key frame may be filtered according to the motion amplitude of each image frame. The key frame may be used to obtain the video sub-segment, so that the motion amplitude is used as the basis for obtaining the video sub-segment, such that the motion amplitude value of the same video sub-segment is used as the division basis, and when the image is automatically annotated, the annotation accuracy of the image may be effectively improved.

In the embodiments of the present disclosure, the step of calculating the motion amplitude value of each image frame may comprise:
calculating an inter-frame difference value corresponding to each image frame in an inter-frame amplitude difference metric, and determining an inter-frame difference value as a motion amplitude value;

Alternatively, the inter-frame optical flow variation amplitude value corresponding to each image frame in the inter-frame optical flow variation metric is calculated, and the inter-frame optical flow variation amplitude value is determined as the motion amplitude value.

Alternatively, based on the pre-trained segmentation model, an intersection over union of segmentation results corresponding to each image frame is calculated, and the intersection over union is determined as a motion amplitude value.

Different types of motion amplitude values may be adopted, and the metric threshold may be determined according to the type of the motion amplitude value.

Optionally, the inter-frame difference may refer to a difference between pixel mean values of two image frames.

The optical flow variation amplitude value may refer to a difference between optical flows of two or more image frames, and an optical flow floating threshold corresponding to each image frame may be obtained through calculation by using an optical flow calculation formula. The calculation of the intersection over union on the segmentation results between each image frame may be calculated, and the intersection over union may refer to performing the segmentation processing on the image frame and its surrounding frames respectively, to obtain a ratio between the interaction and the union between segmentation result of the image frame and the segmentation result of the surrounding frame. If the overlap level of the two is relatively high, the value of the intersection over union is relatively larger, and if the overlap level of the two is relatively low, the value of the intersection over union is relatively small.

In the embodiments of the present disclosure, the motion amplitude value of each image frame may be accurately calculated by applying a plurality of types of manner, through calculating the inter-frame difference, the inter-frame optical flow variation amplitude value, or the intersection over union of the segmentation result corresponding to the image frame.

In one embodiment, determining a sub-segment to be annotated in a video to be annotated to obtain a target sub-segment comprises:
determining a segment sequence respectively corresponding to at least one video sub-segment based on a temporal sequence of the at least one video sub-segment; and
selecting, starting from a first video segment, a video segment as the sub-segment to be annotated based on a segment sequence respectively corresponding to the at least one video sub-segment to obtain the target sub-segment.

Optionally, a segment sequence of each video sub-segment may be determined based on a segment sequence number corresponding to the at least one video sub-segment. The target sub-segment may be determined sequentially from the at least one video sub-segment. After the target sub-segment is obtained, the annotation scheme of the foregoing embodiment may be performed until the traversal of the at least one video sub-segment ends to obtain the annotation result of all the video sub-segments, and the annotation results of all the video sub-segments is integrated to obtain the annotation result of the video to be annotated.

When segmenting the video, for each obtained video sub-segment, and a segment sequence number may be set for the video sub-segment. For example, the segment sequence number of the first obtained video sub-segment is 1, and the segment sequence number of the second video sub-segment is 2.

In the embodiments of the present disclosure, the target sub-segment may be sequentially selected from the at least one video sub-segment according to the segment sequence corresponding to the at least one video sub-segment. The obtaining of the target sub-segment by using the segment sequence can ensure that the corresponding target sub-segment is obtained in sequence, and then the annotation of each target sub-segment is completed in sequence. The sequence and sequential annotation of the at least one video sub-segment are achieved, and the annotation comprehensiveness of the video sub-segment is improved.

In addition, the technical solutions of the present disclosure may also be applied to the field of gaming, for example, which may include application fields such as design, display and the like of a three-dimensional game scene.

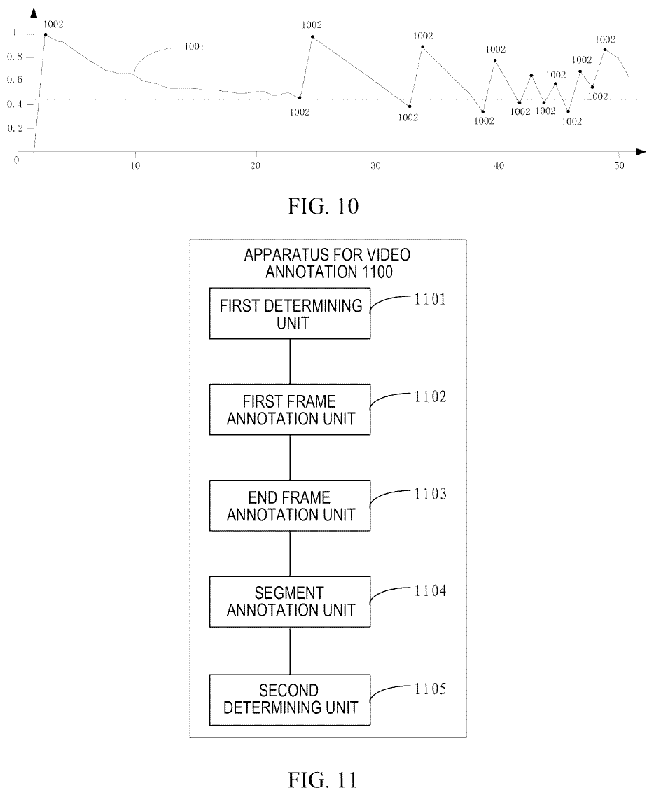

As shown in FIG. 11, FIG. 11 is a schematic structural diagram of an embodiment of an apparatus for video annotation according to an embodiment of the present disclosure. The apparatus may be located in an electronic device and may be configured with the aforementioned method of video annotation. The apparatus for video annotation 1100 may comprise:
a first determining unit 1101, configured to determine a sub-segment to be annotated in a video to be annotated to obtain a target sub-segment;
a first frame annotation unit 1102, configured to obtain a first frame annotation result corresponding to a first frame of the target sub-segment;
an end frame annotation unit 1103, configured to generate an end frame annotation result corresponding to an end frame of the target sub-segment based on the first frame annotation result;
a segment annotation unit 1104, configured to generate an annotation result of an intermediate frame of the target sub-segment based on the first frame annotation result and the end frame annotation result, to obtain an annotation result of the target sub-segment to be annotated;
a second determining unit 1105, configured to generate a target annotation result of the video to be annotated based on the annotation result of the target sub-segment.

In one embodiment, the target obtaining unit comprises:
a key extraction module, configured to extract key frames of the video to be annotated;
a segment obtaining module, configured to divide a video interval enclosed by two adjacent key frames of the key frames in the video to be annotated into a video sub-segment, to obtain at least one video sub-segment; and
a target determining module, configured to determine the target sub-segment to be annotated from the at least one video sub-segment.

In some embodiments, the key extraction module comprises:
an amplitude calculation submodule, configured to, for image frames in the video to be annotated, calculate a motion amplitude value of each image frame; and
the key determining sub-module, configured to obtain the at least one key frame in the image frame based on the motion amplitude value.

In one embodiment, the end frame annotation unit may comprise:
a first frame obtaining module, configured to obtain the first frame annotation result corresponding to the first frame of the target sub-segment;
an end frame generation module, configured to determine, based on the first frame annotation result, the end frame annotation result corresponding to the end frame with a forward propagation algorithm.

In a possible design, the end frame generation module may comprise:
a label propagation sub-module, configured to performing, with the forward propagation algorithm, a sequential propagation of annotation result for the first frame annotation result to an unannotated image frame in the target sub-segment, to obtain an annotation result of the unannotated image frame in the target sub-segment; and
the end frame annotation sub-module, configured to obtaining an annotation result of a last image frame of the target sub-segment as the end frame annotation result corresponding to the end frame.

As another embodiment, the segment annotation unit comprises:
a first extraction module, configured to extract, based on the first frame annotation result and in conjunction with a forward propagation algorithm, a forward propagation feature of the intermediate frame of the target sub-segment.
a second extraction module, configured to extract, based on the end frame annotation result and in conjunction with a backward propagation algorithm, a backward propagation feature of the intermediate frame of the target sub-segment;
a feature fusion module, configured to perform feature fusion processing on the forward propagation feature and the backward propagation feature, to obtain a target image feature of the intermediate frame;
a label determining module, configured to determine the annotation result of the intermediate frame based on the target image feature.

In some embodiments, the feature fusion module may comprise:
a sequence number determining sub-module, configured to determine an image sequence number of the intermediate frame in the target sub-segment; and
a ratio determining submodule, configured to determine a sequence number ratio based on the image sequence number;
a weight determining sub-module, configured to determine a forward propagation weight and a backward propagation weight based on the sequence number ratio; and
a feature weighting sub-module, configured to obtain the target image feature of the intermediate frame based on the forward propagation weight, the backward propagation weight, the forward propagation feature and the backward propagation feature.

In one embodiment, the first frame annotation unit may comprise:
a first frame annotation module, configured to detect an annotation operation performed by a user for the first frame, to obtain the first frame annotation result corresponding to the annotation operation;
alternatively, the first frame determining module is configured to obtain a previous video sub-segment of the target sub-segment, and determining an end frame annotation result corresponding to an end frame of the previous video sub-segment as the first frame annotation result corresponding to the first frame of the target sub-segment.

In one embodiment, the first determining unit may comprise:
a sequence determining module, configured to determine a segment sequence respectively corresponding to at least one video sub-segment based on a temporal sequence of the at least one video sub-segment; and
a segment traversing module, configured to select, starting from a first video segment, a video segment as the sub-segment to be annotated based on a segment sequence respectively corresponding to the at least one video sub-segment to obtain the target sub-segment.

The apparatus provided in this embodiment may be configured to perform the technical solutions in the foregoing method embodiments, and implementation principles and technical effects thereof are similar, and details are not described herein again in this embodiment.

In order to achieve the above embodiments, an embodiment of the present disclosure further provides an electronic device.

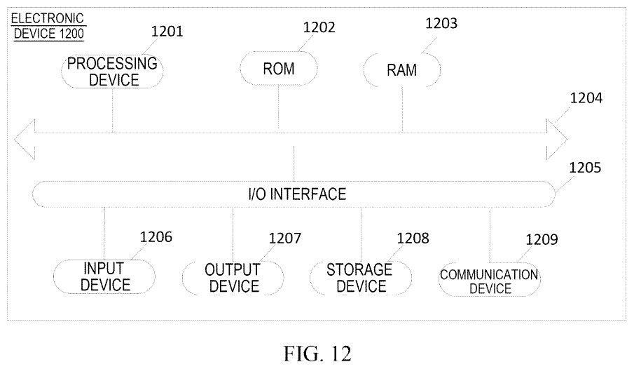

FIG. 12 shows a schematic structural diagram of an electronic device 1200 suitable for implementing embodiments of the present disclosure, and the electronic device 1200 may be a terminal device or a server. The terminal device may include, but is not limited to, a mobile terminal such as a mobile phone, a notebook computer, a digital broadcast receiver, a personal digital assistant (PDA), a tablet computer (Portal Android Device, PAD), a portable multimedia player (PMP), an in-vehicle terminal (for example, an in-vehicle navigation terminal), and a fixed terminal such as a digital TV, a desktop computer, or the like. The electronic device shown in FIG. 12 is merely an example, and should not impose any limitation on the functions and scope of use of the embodiments of the present disclosure.

As shown in FIG. 12, the electronic device 1200 may include a processing device (for example, a central processing unit, a graphics processor, etc.) 1201, which may perform various appropriate actions and processing according to a program stored in a read only memory (ROM) 1202 or a program loaded into a random access memory (RAM) 1203 from a storage device 1208. In the RAM 1203, various programs and data required by the operation of the electronic device 1200 are also stored. The processing device 1201, the ROM 1202, and the RAM 1203 are connected to each other through a bus 1204. Input/output (I/O) interface 1205 is also connected to bus 1204.

Generally, the following apparatus may be connected to the I/O interface 1205: an input device 1206 including, for example, a touch screen, a touch pad, a keyboard, a mouse, a camera, a microphone, an accelerometer, a gyroscope, etc.; an output device 1207 including, for example, a liquid crystal display (LCD), a speaker, a vibrator, etc.; a storage device 1208 including, for example, a magnetic tape, a hard disk, etc.; and a communication device 1209. The communication device 1209 may allow the electronic device 1200 to communicate wirelessly or wired with other devices to exchange data. While FIG. 12 shows an electronic device 1200 having various devices, it should be understood that it is not required to implement or have all illustrated apparatuses. More or fewer apparatuses may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 1209, or installed from the storage device 1208, or from the ROM 1202. When the computer program is executed by the processing device 1201, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or component, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or component. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or component. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

The present disclosure further provides a computer-readable storage medium, where the computer-readable storage medium stores computer-executable instructions, and when the processor executes the computer-executable instructions, the method of video annotation provided in any one of the foregoing embodiments is implemented.

The present disclosure further provides a computer program product, including a computer program, where the computer program is executed by a processor to configure the method of video annotation provided in any one of the foregoing embodiments.

Computer program code for performing the operations of the present disclosure may be written in one or more programming languages, including image-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit of obtaining at least two Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of video annotation, comprising:
determining a sub-segment to be annotated in a video to be annotated to obtain a target sub-segment;
obtaining a first frame annotation result corresponding to a first frame of the target sub-segment;
generating an end frame annotation result corresponding to an end frame of the target sub-segment based on the first frame annotation result;
generating an annotation result of an intermediate frame of the target sub-segment based on the first frame annotation result and the end frame annotation result, to obtain an annotation result of the target sub-segment to be annotated; and
generating a target annotation result of the video to be annotated based on the annotation result of the target sub-segment.

2. The method of claim 1, wherein determining the sub-segment to be annotated in the video to be annotated to obtain the target sub-segment comprises:
extracting key frames of the video to be annotated;
dividing a video interval enclosed by two adjacent key frames of the key frames in the video to be annotated into a video sub-segment, to obtain at least one video sub-segment; and
determining the target sub-segment to be annotated from the at least one video sub-segment.

3. The method of claim 2, wherein extracting at least one key frame of the video to be annotated comprises:
for image frames in the video to be annotated, calculating a motion amplitude value of each image frame;
obtaining the at least one key frame in the image frame based on the motion amplitude value.

4. The method of claim 1, wherein generating the annotation result of the end frame of the target sub-segment based on the first frame annotation result comprises:
obtaining the first frame annotation result corresponding to the first frame of the target sub-segment;
determining, based on the first frame annotation result, the end frame annotation result corresponding to the end frame with a forward propagation algorithm.

5. The method of claim 4, wherein determining, based on the first frame annotation result, the end frame annotation result corresponding to the end frame with the forward propagation algorithm comprises:
performing, with the forward propagation algorithm, a sequential propagation of annotation result for the first frame annotation result to an unannotated image frame in the target sub-segment, to obtain an annotation result of the unannotated image frame in the target sub-segment;
obtaining an annotation result of a last image frame of the target sub-segment as the end frame annotation result corresponding to the end frame.

6. The method of claim 1, wherein generating the annotation result of the intermediate frame of the target sub-segment based on the first frame annotation result and the end frame annotation result comprises:
extracting, based on the first frame annotation result and in conjunction with a forward propagation algorithm, a forward propagation feature of the intermediate frame of the target sub-segment;
extracting, based on the end frame annotation result and in conjunction with a backward propagation algorithm, a backward propagation feature of the intermediate frame of the target sub-segment;
performing feature fusion processing on the forward propagation feature and the backward propagation feature, to obtain a target image feature of the intermediate frame;
determining the annotation result of the intermediate frame based on the target image feature.

7. The method of claim 6, wherein performing the feature fusion processing on the forward propagation feature and the backward propagation feature to obtain the target image feature of the intermediate frame comprises:
determining an image sequence number of the intermediate frame in the target sub-segment;
determining a sequence number ratio based on the image sequence number;
determining a forward propagation weight and a backward propagation weight based on the sequence number ratio;
obtaining the target image feature of the intermediate frame based on the forward propagation weight, the backward propagation weight, the forward propagation feature and the backward propagation feature.

8. The method of claim 1, wherein obtaining the first frame annotation result corresponding to the first frame of the target sub-segment comprises:
detecting an annotation operation performed by a user for the first frame, to obtain the first frame annotation result corresponding to the annotation operation; or
obtaining a previous video sub-segment of the target sub-segment, and determining an end frame annotation result corresponding to an end frame of the previous video sub-segment as the first frame annotation result corresponding to the first frame of the target sub-segment.

9. The method of claim 1, wherein determining the sub-segment to be annotated in the video to be annotated to obtain the target sub-segment comprises:
determining a segment sequence respectively corresponding to at least one video sub-segment based on a temporal sequence of the at least one video sub-segment;
selecting, starting from a first video segment, a video segment as the sub-segment to be annotated based on a segment sequence respectively corresponding to the at least one video sub-segment to obtain the target sub-segment.

10. (canceled)

11. An electronic device, comprising: a processor and a memory;
the memory storing computer-executable instructions;
the processor executing the computer-executable instructions stored in the memory, such that the processor is configured with a method of video annotation comprising:
determining a sub-segment to be annotated in a video to be annotated to obtain a target sub-segment;
obtaining a first frame annotation result corresponding to a first frame of the target sub-segment;
generating an end frame annotation result corresponding to an end frame of the target sub-segment based on the first frame annotation result;
generating an annotation result of an intermediate frame of the target sub-segment based on the first frame annotation result and the end frame annotation result, to obtain an annotation result of the target sub-segment to be annotated; and
generating a target annotation result of the video to be annotated based on the annotation result of the target sub-segment.

12-13. (canceled)

14. The electronic device of claim 11, wherein determining the sub-segment to be annotated in the video to be annotated to obtain the target sub-segment comprises:
extracting key frames of the video to be annotated;
dividing a video interval enclosed by two adjacent key frames of the key frames in the video to be annotated into a video sub-segment, to obtain at least one video sub-segment; and
determining the target sub-segment to be annotated from the at least one video sub-segment.

15. The electronic device of claim 14, wherein extracting at least one key frame of the video to be annotated comprises:
for image frames in the video to be annotated, calculating a motion amplitude value of each image frame;
obtaining the at least one key frame in the image frame based on the motion amplitude value.

16. The electronic device of claim 11, wherein generating the annotation result of the end frame of the target sub-segment based on the first frame annotation result comprises:
obtaining the first frame annotation result corresponding to the first frame of the target sub-segment;
determining, based on the first frame annotation result, the end frame annotation result corresponding to the end frame with a forward propagation algorithm.

17. The electronic device of claim 16, wherein determining, based on the first frame annotation result, the end frame annotation result corresponding to the end frame with the forward propagation algorithm comprises:
performing, with the forward propagation algorithm, a sequential propagation of annotation result for the first frame annotation result to an unannotated image frame in the target sub-segment, to obtain an annotation result of the unannotated image frame in the target sub-segment;
obtaining an annotation result of a last image frame of the target sub-segment as the end frame annotation result corresponding to the end frame.

18. The electronic device of claim 11, wherein generating the annotation result of the intermediate frame of the target sub-segment based on the first frame annotation result and the end frame annotation result comprises:
extracting, based on the first frame annotation result and in conjunction with a forward propagation algorithm, a forward propagation feature of the intermediate frame of the target sub-segment;
extracting, based on the end frame annotation result and in conjunction with a backward propagation algorithm, a backward propagation feature of the intermediate frame of the target sub-segment;
performing feature fusion processing on the forward propagation feature and the backward propagation feature, to obtain a target image feature of the intermediate frame;
determining the annotation result of the intermediate frame based on the target image feature.

19. The electronic device of claim 18, wherein performing the feature fusion processing on the forward propagation feature and the backward propagation feature to obtain the target image feature of the intermediate frame comprises:
determining an image sequence number of the intermediate frame in the target sub-segment;
determining a sequence number ratio based on the image sequence number;
determining a forward propagation weight and a backward propagation weight based on the sequence number ratio;
obtaining the target image feature of the intermediate frame based on the forward propagation weight, the backward propagation weight, the forward propagation feature and the backward propagation feature.

20. The electronic device of claim 11, wherein obtaining the first frame annotation result corresponding to the first frame of the target sub-segment comprises:
detecting an annotation operation performed by a user for the first frame, to obtain the first frame annotation result corresponding to the annotation operation; or
obtaining a previous video sub-segment of the target sub-segment, and determining an end frame annotation result corresponding to an end frame of the previous video sub-segment as the first frame annotation result corresponding to the first frame of the target sub-segment.

21. The electronic device of claim 11, wherein determining the sub-segment to be annotated in the video to be annotated to obtain the target sub-segment comprises:
determining a segment sequence respectively corresponding to at least one video sub-segment based on a temporal sequence of the at least one video sub-segment;
selecting, starting from a first video segment, a video segment as the sub-segment to be annotated based on a segment sequence respectively corresponding to the at least one video sub-segment to obtain the target sub-segment.

22. A non-transitory computer-readable storage medium, the computer-readable storage medium storing computer-executable instructions, a processor, when executing computer-executable instructions, implementing a method of video annotation comprising:
determining a sub-segment to be annotated in a video to be annotated to obtain a target sub-segment;
obtaining a first frame annotation result corresponding to a first frame of the target sub-segment;
generating an end frame annotation result corresponding to an end frame of the target sub-segment based on the first frame annotation result;
generating an annotation result of an intermediate frame of the target sub-segment based on the first frame annotation result and the end frame annotation result, to obtain an annotation result of the target sub-segment to be annotated; and
generating a target annotation result of the video to be annotated based on the annotation result of the target sub-segment.

23. The non-transitory computer-readable storage medium of claim 22, wherein determining the sub-segment to be annotated in the video to be annotated to obtain the target sub-segment comprises:
extracting key frames of the video to be annotated;
dividing a video interval enclosed by two adjacent key frames of the key frames in the video to be annotated into a video sub-segment, to obtain at least one video sub-segment; and
determining the target sub-segment to be annotated from the at least one video sub-segment.
